(19) United States
(12) Patent Application Publication
(10) Pub. No.: US 2021/0331106 A1
(43) Pub. Date: Oct. 28, 2021

(54) OIL, DEBRIS SEPARATOR, FILTER AND MUFFLER STRUCTURE

(71) Applicant: Hanon Systems, Daejeon (KR)

(72) Inventors: Michael G. Theodore, JR., Plymouth, MI (US); Kanwal Bhatia, Canton, MI (US); Carl Cordy, Ypsilanti, MI (US)

(21) Appl. No.: 16/855,074

(22) Filed: Apr. 22, 2020

(51) Int. Cl. B01D 36/00; B01D 33/80; B01D 33/00; B01D 29/00

(52) U.S. Cl. CPC B01D 36/008; B01D 29/0097; B01D 33/0009; B01D 33/804

(57) ABSTRACT

An oil separator comprising includes a vessel body defining a chamber configured to receive a mixture of an oil and a coolant and a vane disposed in the chamber. The vane is configured to separate the oil from the coolant from the mixture of the oil and the coolant. A filter screen having a non-planar surface for filtering the oil is included with the oil separator.

### FIELD

The invention relates to a device for filtering and separating oil in systems requiring debris free and/or cool oil.

### BACKGROUND

Current mechanical systems involving moving parts, such as engine circuits of a vehicle or heating, cooling, and ventilating (HVAC) systems, for example, employ filter means to remove debris from oil or lubrication flows so the moving parts function properly. Lubrication is desired to maximize durability of devices in the engine and the HVAC systems such as an engine, a compressor, and other moving mechanical parts. The debris occurs due to coatings or components of moving parts wearing. However, many of the filters can easily become clogged. Once the filter is clogged, the filtration process is compromised and/or the flow of oil through the filter is decreased. Once the filters become clogged, the filters must be replaced or fixed. An undesired amount of down time or inoperable time must be implemented to replace or refurbish the filters which can also be expensive.

Additionally, as the desire for debris free oil increases, screens with smaller meshes are being employed in the filters. As the meshes become smaller, the required replacement or maintenance of the filters becomes more frequent. Increased replacement and maintenance results in an increase in part cost, labor cost, inconvenience, waste, and damage to the environment.

Furthermore, filters are typically integrated within the engine systems and the HVAC systems at portions thereof that are difficult to access without disassembling large portions of the systems. For example, the filters in an HVAC system may be integrated with the compressor. As a result, the compressor and any adjacent component must be disassembled which is time consuming and costly. Any coolant material must also be removed from the system and then replaced within the system. Such removal and replacement can result in undesired waste and can be environmentally and physically hazardous.

As the industry begins to only accept cleaner oil with smaller particles, such as 0.5 millimeters or less, and require longer intervals between maintenance, labor and parts for the engine and HVAC systems have become increasingly costly. In order to provide a clean system, the moving parts have to be washed and cleaned to remove a majority of the debris. For example, a compressor must be cleaned and washed many times before positioning the compressor within the systems so less debris flows with the oil. Building a clean compressor is very costly and labor intensive.

It is also known that as the filters become clogged, the oil becomes hotter due to less oil being conveyed to the moving parts. With less oil, the moving parts produce more heat and transfer the heat to the oil. As heat increases in the oil, the oil loses viscosity and velocity of the flow decreases. In turn, longevity of the parts is decreased.

It would therefore be desirable to provide a device for filtering oil in mechanical systems that minimizes cost, waste, assembly time, and maintenance time, is easily accessible, and maximizes filtration of debris from and cooling of the oil.

### SUMMARY

In accordance and attuned with the present disclosure, a device for filtering oil in mechanical systems that minimizes cost, waste, assembly time, and maintenance time, is easily accessible, and maximizes filtration of debris from and cooling of the oil has surprisingly been discovered.

According to an embodiment of the instant disclosure, an oil separator comprising includes a vessel body defining a chamber configured to receive a mixture of an oil and a coolant and a vane disposed in the chamber. The vane is configured to separate the oil from the coolant from the mixture of the oil and the coolant. A filter screen having a non-planar surface for filtering the oil is included with the oil separator.

According to another embodiment of the disclosure, a heat exchanger assembly is disclosed. The assembly includes a heat exchanger and an oil separator including a vessel body defining a chamber configured to receive a mixture of an oil and a coolant. The oil separator further includes a vane disposed in the chamber. The vane is configured to centrifugally affect the flow of the mixture of the oil and the coolant. A filter screen has a dome shape for filtering the oil from the mixture of the oil and the coolant.

### DRAWINGS

The above, as well as other objects and advantages of the invention, will become readily apparent to those skilled in the art from reading the following detailed description of an embodiment of the invention when considered in the light of the accompanying drawing which:

FIG. 1 illustrates an exploded perspective view of an oil separator according to an embodiment of the present disclosure;

FIG. 2 illustrates a cross-sectional elevational view of the oil separator of FIG. 1 taken along an axial plane of a vessel body of the oil separator;

FIG. 3 illustrates a top perspective view of a bottom cover of the oil separator of FIGS. 1-2;

FIG. 4 illustrates a top perspective view of the top cover of the oil separator of FIGS. 1-2;

FIG. 5 illustrates a top perspective view of a filter screen of the oil separator of FIGS. 1-2;

FIG. 6 illustrates a bottom perspective view of a vane of the oil separator of FIGS. 1-2;

FIG. 7 illustrates an enlarged fragmentary cross-sectional view of an oil separator according to another embodiment; and

FIG. 8 illustrates a cross-sectional elevational view of an oil separator according to another embodiment.

### DETAILED DESCRIPTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

As used herein, substantially is defined as “to a considerable degree” or “proximate” or as otherwise understood by one ordinarily skilled in the art. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

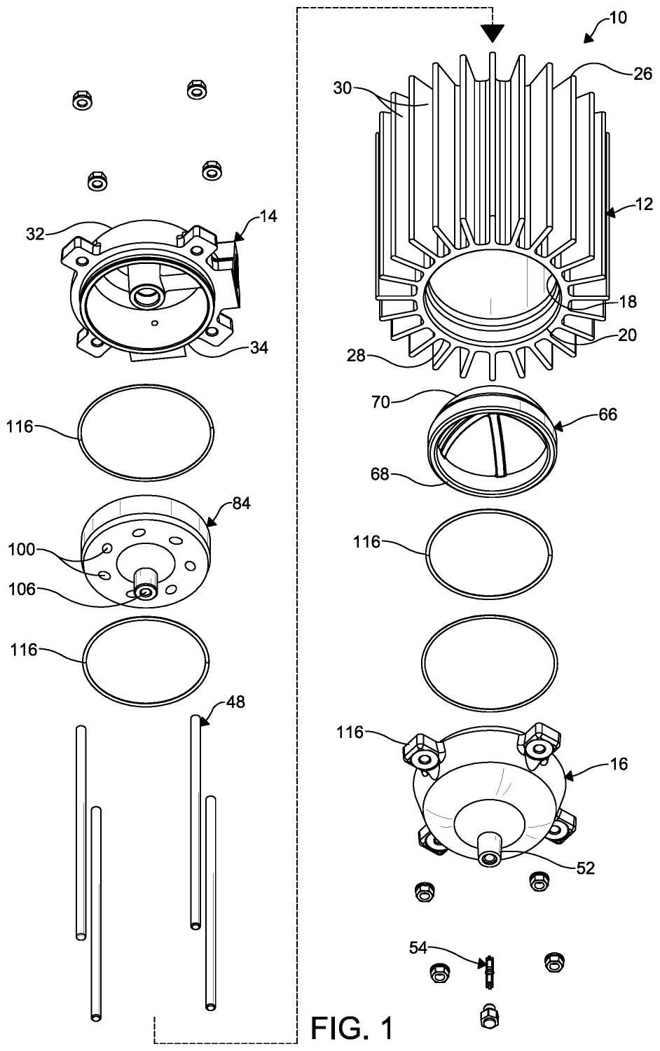

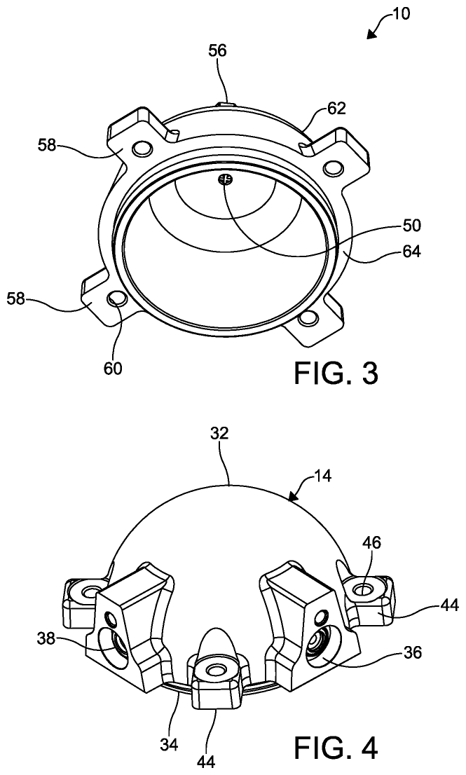

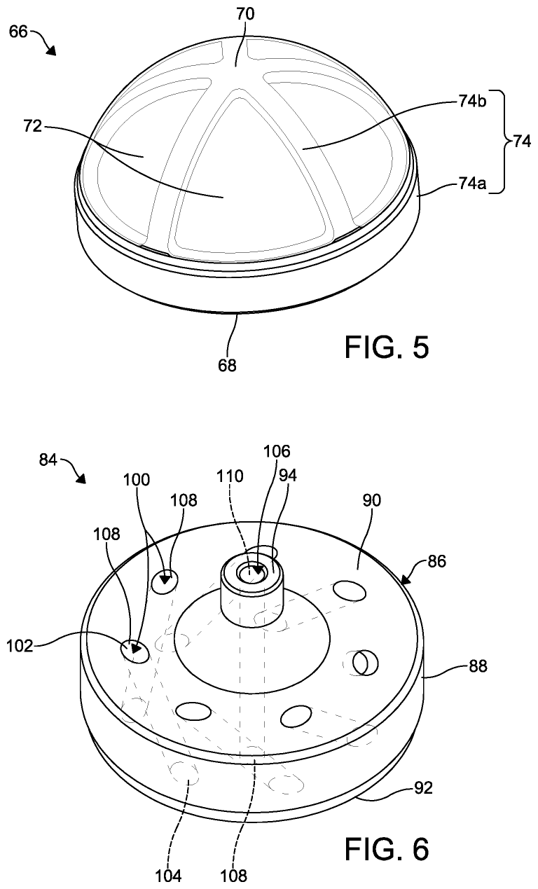

FIGS. 1-6 show an oil separator 10 according to an example of the present disclosure. The oil separator 10 is configured for use in oil systems for lubricating mechanical parts. For example, the oil separator 10 is configured for use in heating, ventilating, and cooling (HVAC) systems of a vehicle such as filtering and separating oil for use in lubricating a compressor or parts thereof such as pistons, rotary vane, rotary screws, etc., of the HVAC systems. However, it is understood the oil can be employed for lubrication or cooling of any components of the HVAC system. In another example, the oil separator 10 is configured for use in an engine system of the vehicle such as filtering and separating oil for use in lubricating an engine of the engine system. However, it is understood the oil can be employed for lubrication or cooling any components of the engine system. In yet another example, the oil separator 10 is configured for use in any HVAC or coolant system, any engine systems such as dry sump type engine systems, and any hydraulic systems such as basic hydraulic systems, automatic transmission systems, aircraft hydraulic systems, or any other type of hydraulic systems as desired. It is understood the oil separator 10 can be employed in any system containing an oil or lubricant without departing from the scope of the instant disclosure.

The oil separator 10 includes a vessel body 12, a top cover 14, and a bottom cover 16 cooperating with each other to define a chamber 18. The vessel body 12 includes a wall 20 having an inner surface 22 defining a portion of the chamber 18 and an outer surface 24. The wall 20 is substantially cylindrical in shape having a first open end 26 and a second open end 28 opposite the first open end 26. An annular array of fins 30 extend radially outwardly from the outer surface 24 of the wall. In the embodiment illustrated, the wall 20 includes twenty-four fins 30 integrally formed with the wall 20. However, it is understood, the wall can include more than or fewer than twenty-four of the fins 30 and the fins 30 can be separately formed from the wall 20 and coupled to the wall 20. The fins 30 are configured as a heat transfer feature, wherein the heat transfer feature increases a surface area for exchanging heat between a fluid flowing about the fins 30 and the vessel body 12. It is understood, the heat transfer feature can be other features or devices such as a heat sink, fluid jacket, cooling modules such as tubes or plates, or any other heat transfer feature as desired. The fluid flowing about the fins 30 can be air for example. However, the fluid flowing about the fins 30 can be other types of coolant, if desired.

The top cover 14 is coupled to the first open end 26 of the vessel body 12. The top cover 14 is dome shaped and includes a closed end 32 and an open end 34 in fluid communication with the chamber 18. The top cover 14 includes an inlet port 36 for receiving a mixture (represented by a solid line) of oil and coolant and an outlet port 38 for conveying coolant (shown by a dotted line) separated from the mixture therefrom. A partition 40 extends from an inner surface of the top cover 14 and defines a cavity 42 in fluid communication with the outlet port 38. As shown, the cavity 42 and outlet port 38 are substantially perpendicular to each other so that a flow of the coolant through the cavity 42 flows in an axial direction with respect to the wall 20 of the vessel body 12 and the coolant flows through the outlet port 38 in a direction perpendicular to the axial direction with respect to the wall 20 of the vessel body 12. It is understood, the outlet port 38 and the cavity 42 can extend in any direction as desired. The top cover 14 has a lip 43 formed at the open end 34 thereof for engaging the inner surface 22 of the wall 20. The top cover 14 includes flanges 44 with apertures 46 for engaging couplers 48 such as coupling rods, for example, to couple the top cover 14 to the oil separator 10. However, it is understood, other coupling devices or methods can be employed to couple the top cover to the oil separator 10, if desired.

The bottom cover 16 is coupled to the second open end 28 of the vessel body 12. The bottom cover 16 has a trapezoidal cross-sectional shape. However, the bottom cover 16 can have any cross-section shaped as desired such as rectangular, polygonal, arcuate, dome shaped, or any other shape as desired. The bottom cover 16 includes a closed end 62 and an open end 64 in fluid communication with the wall 20. The bottom cover 16 is configured as a catch basin for receiving and accumulating oil (represented by the dashed arrows). A hole 50 is formed in a central portion of the closed end 62 of the bottom cover 16. However, the hole 50 can be formed at any portion of the closed end 62, if desired. The hole 50 is in fluid communication with a drain channel 52 extending outwardly from and integrally with the closed end 62 of the bottom cover 16. The drain channel 52 conveys the oil from the oil separator 10 to an oil system of the vehicle, for example. The bottom cover 16 includes flanges 58 with apertures 60 for engaging with the couplers 48 such as coupling rods, for example, to couple the bottom cover 16 to the oil separator 10. In the embodiment illustrated, the apertures 46 of the top cover 14 align with the apertures 60 of the bottom cover 16, wherein the couplers 48 urge the top cover 14 towards the bottom cover 16. As a result, the top cover 14 and the bottom cover 16 sealingly engage the respective ends 26, 28 of the vessel body 12. However, it is understood, other coupling devices or methods can be employed to couple the top cover to the oil separator 10, if desired.

An orifice 54 is received in the drain channel 52. The orifice 54 is configured to convey the oil separated from the mixture of oil and coolant from a high pressure destination from within the oil separator to a low pressure destination such as outside of the oil separator. For example, the orifice 54 is configured for conveying the oil back to the desired oil system to a component such as a compressor, engine, pump, etc. The orifice 54 can be a variable feed orifice to control a flow of the oil to the desired component since a flow required for the desired component may vary depending on operating conditions of the systems. The orifice 54 includes a nozzle 56 for coupling the orifice to the bottom cover 16. The nozzle 56 is configured to adjust the flow of the oil through the orifice 54 and out from the oil separator 10.

A filter screen 66 is disposed adjacent to and engages the open end 64 of the bottom cover 16. The filter screen 66 includes an open end 68 and a closed mesh end 70. The closed mesh end 70 is arcuate in shape and extends convex with respect to the open end 64 of the bottom cover 16. The filter screen 66 is substantially dome shaped or semi-spherical shaped. The dome shape of the filter screen 66 is particularly advantageous as will be described herein below. The filter screen 66 includes mesh portions 72 supported by framework 74. The mesh portions 72 include mesh or latticing forming perforations. The perforations can have any diameter or width as desired. However, it has been found mesh with perforations having a diameter or width equal to or less than about 500 micrometers is beneficial. However, the mesh can be any size as desired depending on the application. In the embodiment illustrated, the framework 74 consists of an annular band 74a and a plurality of arcuate bands 74b extending from the annular band 74a. The arcuate bands 74b divide the mesh portions 72 into a plurality of separate mesh portions 72. However, the framework 74 can be any frame work as desired and include different frame features to support the mesh portions 72. It is understood, the entirety of the closed mesh end 70 can be mesh without framework, if desired, for example.

The open end 68 of the filter screen 66 engages a lip 76 extending outwardly from the open end 64 of the bottom cover 16. A shoulder 78 defined by the lip 76 and the open end 64 of the bottom cover 16 engages the second open end 28 of the vessel body 12. The filter screen 66 is positioned within the portion of the chamber 18 defined by the vessel body 12 and engaged the inner surface 22 of the wall 20. The filter screen 66 maintains an engaging position within the chamber 18 against the bottom cover 16 by an interference fit between the wall 20 and the filter screen 66. A stop 80 is formed in the inner surface 22 of the wall 20 to militate against displacement of the filter screen 66 in an axial direction with respect to the vessel body 12 away from the bottom cover 16. A recess 82 may also be formed on the inner surface of the wall 20 for receiving the lip 76 of the bottom cover 16. It is understood, the filter screen 66 can be coupled to the wall 20 by other means of coupling such as soldering, welding, threads, pins, bolts, or other means.

A centrifugal swirl vane 84 is received in the chamber 18 adjacent the first open end 26 of the vessel body 12. The vane 84 includes a cylindrical body 86 having a diameter substantially equal to an inner diameter of the wall 20 of the vessel body 12. The cylindrical body 86 includes an outer circumferential wall 88, a first end surface 90, a second end surface 92 opposing the first end surface 90, a first protuberance 94 extending from the first end surface 90, and a second protuberance 96 extending from the second end surface 92. Each of the protuberances 94, 96 is centrally positioned with respect to the outer circumferential wall 88 and have a substantially frustoconical portion adjacent the respective surfaces 90, 92, and an outer substantially cylindrical portion. However, it is understood the protuberances 94, 96 can be disposed in other positions with respect to the outer circumferential wall 88 and can be otherwise shaped as desired.

The vane 84 includes a plurality of first passageways 100 radially formed through the cylindrical body 86 about the center thereof. The first passageways 100 extend from the first end surface 90 to the second end surface 92 each defining an inlet 102 for receiving the mixture of oil and coolant and an outlet 104 for conveying the mixture of oil and coolant into the chamber 18. Thus, the first passageways 100 are fluidly connected to the chamber 18 and the top cover 14. The first passageways 100 are angled with respect to the first end surface 90. In the embodiment shown, the first passageways 100 are angled along a negative slope from the first end surface 90 to the second end surface 92, wherein the inlets 102 are positioned along a first arcuate path and the outlets 104 are positioned along a second arcuate path substantially aligning with the first arcuate path with respect to an axial direction of the can 84. In the embodiment illustrated each of the outlets 104 are disposed on the second arcuate path in a counterclockwise direction from the respective ones of the inlets 102 positioned on the first arcuate path. However, it is understood the first passageways 100 can be angled radially inwardly or radially outwardly with respect to the center of the cylindrical body 86, if desired. In the embodiment illustrated, there are seven of the first passageways 100 spaced equally from each other. However, it is understood, more than or fewer than seven of the first passageways 100 can be formed equally or unequally from each other in the cylindrical body 86, if desired.

A second passageway 106 is formed through the cylindrical body 86 at the center of the cylindrical body 86. The second passage way 106 extends through the protuberances 94, 96 and defines an inlet 108 for receiving the coolant separated from the mixture of oil and coolant and an outlet 110 for conveying the coolant from the vane 84. The second passageway 106 is partially received in and fluidly connected to the cavity 42 of the top cover 14. As a result, the cavity 42 fluidly connects the second passageway 106 to the outlet port 38. The first protuberance 94 extends from the vane 84 into the top cover 14 and the second protuberance 96 extends from the vane 84 into the chamber 18 when the top cover 14, vessel body 12, and vane 84 are coupled to each other.

A stop 112 is formed on the inner surface 22 of the vessel body 12 to militate against the vane 84 moving axially in the chamber 18 towards the second open end 28 of the vessel body 12. A shoulder 114 defined by the lip 43 of the top cover 14 and the open end 34 of the top cover 14 engages the first open end 26 of the vessel body 12 to militate against the top cover 14 moving axially in the chamber 18 towards the second opened end 28.

The oil separator 10 includes a plurality of seals 116. In the embodiment illustrated, the seals 116 are disposed intermediate inner surface 22 of the vessel body 12 and the bottom cover 16, intermediate the inner surface 22 of the vessel body 12 and the filter screen 66, intermediate the inner surface 22 of the vessel body 12 and the vane 84, and intermediate the inner surface 22 of the vessel body 12 and the top cover 16. However, seals can be positioned anywhere in the oil separator 10, if desired.

In application, the mixture of oil and coolant is received in the top cover 14. The mixture of oil and coolant is received from a coolant system for example such as from a coolant system with a compressor, for example. When the mixture of oil and coolant is received at a desired flow rate, such as when the coolant system is operating, the mixture of oil and coolant enters through the inlet port 36 to the top cover 14 and through the inlets 102 of the first passageways 100. Thereafter, the mixture of oil and coolant flows through the first passageways 100 and through the outlets 104 of the first passageways 100 into the chamber 18 of the vessel body 12.

The orientation of the first passageways 100 causes a centrifugal force on the mixture of the oil and coolant as the mixture of the oil and coolant exits through the outlets 104 of the first passageways 100. As a result, a centrifugal swirl effect is imparted onto the mixture of the oil and coolant causing the oil and the coolant to separate from the mixture of the oil and the coolant. The oil, which is in fluid form and thus has a greater density than the coolant is biased towards the inner surface 22 of the vessel body 12. Any undesired debris (represented by letter “D”) within the oil is also biased towards the inner surface 22 of the vessel body. The oil and the debris D travels towards the filter screen 66.

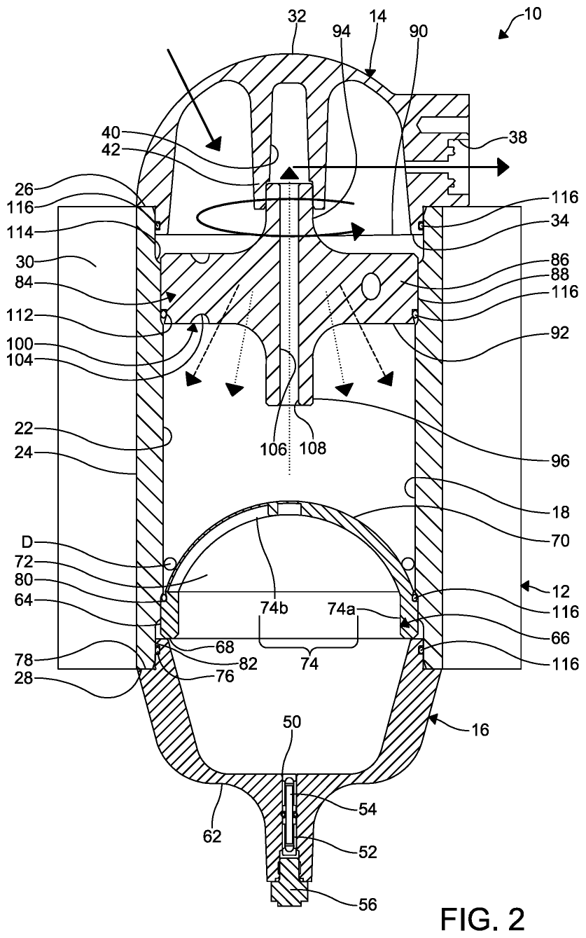

The oil flows through the mesh portion 72 of the filter screen 66 and is received in the bottom cover 16. As the oil accumulates in the bottom cover 16, the oil flows through the orifice 64. The mesh portion 72 ensures only the oil flows therethrough and the debris D does not flow therethrough. The shape of the filter screen 66 causes the debris D to flow towards the outer circumferential portions as shown in FIG. 2. As a result, the filter screen 66 will only become blocked or prevent the oil from entering the mesh portion 72 at the outer circumference portion thereof. This prolongs the life and interval of time between maintenance of the oil separator 10.

Simultaneously, the oil that is biased towards the inner surface 22 of the vessel body 12 travels downwardly towards the filter screen 66. While traveling, the fins 30 transfer heat from the oil, thus cooling the oil. Advantageously, the cooled oil becomes more viscous. A more viscous oil has better lubricating qualities.

The oil exits the orifice 54 through the nozzle and travels from the oil separator which is a high pressure environment to the desired device, which is a low pressure environment, to be lubricated such as a compressor, pump, rotary vane, rotary screw, or any other device as desired.

The coolant, separated from the oil, travels from the chamber 18, through the inlet 108 of the second passageway 106, to the cavity 42 of the top cover 14, and outwardly from the oil separator 10 through the outlet port 38. The coolant is then able to flow to coolant system.

The oil separator 10 is directly connected to or directly adjacent to a heat exchanger 200 of the coolant system such as a radiator, condenser, or other types of heat exchangers. For example the heat exchanger is a condenser, an evaporator, a gas cooler, and a vaporizer, or any other type of heat exchanger. However, it is understood, the oil separator 10 can be directly connected or adjacently connected to other devices receiving the coolant if desired without departing from the scope of the instant disclosure. The positioning of the oil separator 10 with respect to the heat exchanger 100 permits the oil separator 10 to be incorporated into systems without being directly connected to the device needing the oil such as a compressor for example. Specifically, the oil separator 10 can be integrated in the end tanks of the heat exchanger 100. Therefore, an increase in heat transfer efficiency is realized and thus an increase in the coolant system coefficient of performance is realized. Also, connection conduits or lines can be minimized due to the integration of the oil separator 10 to the heat exchanger 200. As a result, minimized components are utilized and leaks are minimized and cost efficiency if maximized.

The oil separator 10 configured according to the instant disclosure permits the oil separator to contain a larger volume of oil compared to prior art oil separators which prolongs the life of the oil separator 10.

Advantageously, the arrangement of the vane 84 separated the oil separator 10 into two zones: the top cover 14 and the chamber 18. This creates an “expansion-contraction-expansion” process resulting in a muffling action. As such, the oil separator 10 acts as a muffler and improves the noise, harshness, and vibration (NHV) of the systems incorporating the oil separator 10. The muffling action can vary depending on the application and the number of the first passageways 100 in the vane 84. The first passageways 100 also minimize pressure drops or choking through the systems utilizing the oil separator 10. As a result, flow rates of the coolant are improved which maximizes system performance.

In another embodiment shown in FIG. 6, a flow of the oil from the orifice 54 of the oil separator 10 can be varied. The same reference numerals used to describe features of the oil separator 10 of FIGS. 1-5 are employed to show the same features as the oil separator 10 of FIG. 6 for convenience. As shown, a variable device 300 is positioned at the distal end of the orifice 54. The variable device 300 can be any device configured to vary the flow of the oil exiting the oil separator 10. For example, the variable device can be a variable orifice, wherein the internal volume of the orifice varies. In another example, the variable device can be a control valve either mechanically or electronically controlled.

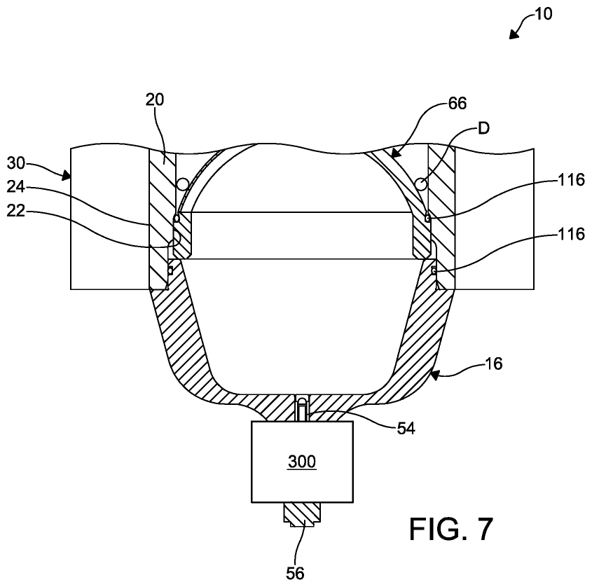

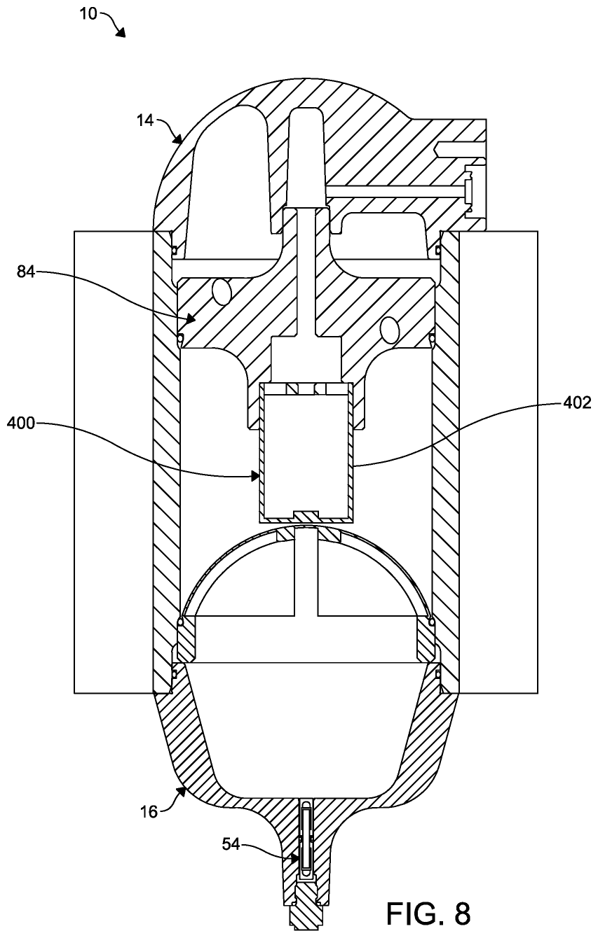

In yet another embodiment as shown in FIG. 7, the oil separator 10 includes a coolant filter 400 disposed intermediate the vane 84 and the filter screen 66. The same reference numerals used to describe features of the oil separator 10 of FIGS. 1-5 are employed to show the same features as the oil separator 10 of FIG. 7 for convenience. The coolant filter 400 is configured to militate against the debris D from exiting the oil separator 10 through the outlet port 38 of the top cover 14. In applications or instances where flows or turbulence of the mixture of the oil and coolant are high, the coolant filter 400 maintains the debris D within the chamber 18.

The coolant filter 400 is substantially cylindrical. However, the coolant filter 400 can be alternately shaped. An upper portion of the coolant filter 400 is received in the second passageway 106 formed in the second protuberance 96. The diameter of the second passageway 106 formed in the second protuberance 96 shown in FIG. 7 is larger than the diameter of the second passageway 106 formed in the second protuberance 96 of FIGS. 1-5. The diameter of the second passageway 106 formed in the second protuberance 96 of FIG. 7 is substantially the same as the diameter of the coolant filter 400 to ensure a seal with the second passageway 106. The coolant filter 400 includes holes or mesh portions 402 for receiving the coolant but not the debris D.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An oil separator comprising:
a vessel body defining a chamber configured to receive a mixture of an oil and a coolant;
a vane disposed in the chamber, the vane configured to separate the oil from the coolant from the mixture of the oil and the coolant; and
a filter screen having a non-planar surface for filtering the oil.

2. The oil separator of claim 1, wherein the vane exerts a centrifugal force on the mixture of oil and coolant.

3. The oil separator of claim 1, wherein the filter screen is dome shaped.

4. The oil separator of claim 1, wherein the filter screen includes mesh portions having a mesh less than or equal to 500 micrometers.

5. The oil separator of claim 1, wherein the vane includes a plurality of first passageways formed through the vane about a center of the vane.

6. The oil separator of claim 5, wherein the plurality of first passageways is angled with respect to a surface of the vane receiving the mixture of oil and coolant.

7. The oil separator of claim 5, wherein the vane includes a second passageway formed therethrough, the second passageway conveying the coolant outwardly from the vessel body.

8. The oil separator of claim 1, wherein the vane separates debris from the mixture of oil and coolant.

9. The oil separator of claim 1, wherein the filter screen militates against the debris from flowing therethrough and permits the oil to flow therethrough.

10. The oil separator of claim 1, wherein the vessel body includes a plurality of fins extending radially outwardly therefrom.

11. The oil separator of claim 1, further comprising
a top cover for receiving the mixture of oil and coolant from outside of the oil separator and conveying the coolant outwardly from the oil separator;
a bottom cover disposed downstream from the filter screen with respect to a flow of the oil through the oil separator, the bottom cover receiving the oil; and
an orifice in fluid communication with the bottom cover, the orifice conveying the oil outwardly from the oil separator.

12. The oil separator of claim 11, wherein the flow of the oil from the orifice is varied.

13. The oil separator of claim 1, wherein the oil separator is disposed in or directly adjacent to a heat exchanger.

14. The oil separator of claim 1, further comprising a coolant screen disposed intermediate the filter screen and the vane.

15. A heat exchanger assembly comprising:
a heat exchanger;
an oil separator including:
a vessel body defining a chamber configured to receive a mixture of an oil and a coolant;
a vane disposed in the chamber, the vane configured to centrifugaly affect the flow of the mixture of the oil and the coolant; and
a filter screen having dome shape for filtering the oil from the mixture of the oil and the coolant.

16. The heat exchanger assembly of claim 15, wherein the heat exchanger is one of a condenser, an evaporator, a gas cooler, and a vaporizer.

17. The heat exchanger assembly of claim 15, wherein the mixture of the oil and the coolant flowing through the vane separates the oil and the coolant.

18. The heat exchanger assembly of claim 15, wherein the filter screen is convex with respect to a flow of the oil flowing through the screen.

19. The heat exchanger assembly of claim 15, wherein the vessel body includes fins.

20. The heat exchanger assembly of claim 20, further comprising a coolant filter.
